(19) United States
(12) Patent Application Publication
(10) Pub. No.: US 2012/0064215 A1
(43) Pub. Date: Mar. 15, 2012

(54) Portable towable stove for outdoor use

(76) Inventor: Marcel Albert Michaud, Rutherglen (CA)

(21) Appl. No.: 13/228,380

(22) Filed: Sep. 8, 2011

Related U.S. Application Data
(60) Provisional application No. 61/381,348, filed on Sep. 9, 2010.

(51) Int. Cl. A23L 1/01; F24C 1/16

(52) U.S. Cl. 426/523; 126/276

(57) ABSTRACT

A portable stove for outdoor enthusiasts has, in one embodiment, a tow bar (22) to be connected to a towing vehicle such as an all-terrain-vehicle or snowmobile. The tow bar is connected to a crossbar (32), that together support a base (30). The base holds a fire compartment (20) in which solid, liquid, or gaseous fuel can be burned. Wheels (46) or skis (26) can be connected to tow the stove over a variety of terrains. A cover (38) encloses the fire compartment during transport and spins out to serve as a table while cooking or heating. A grill (50) can be adjusted in height to vary the cooking temperature, and can be spun out away from the fire compartment to give clear access to the fire compartment or to remove the food from the heat. Other embodiments are described and shown.

### CROSS-REFERENCE TO RELATED APPLICATIONS

This application claims the benefit of provisional patent application Ser. No. 61,381,348, filed 2010 Sep. 9 by the present inventor.

### BACKGROUND

### Prior Art

The following is a tabulation of some prior art that presently appears relevant:

U.S. Patents

| Pat. No. | Kind Code | Issue Date | Patentee |
|---|---|---|---|
| 2,677,363 | | 1984 May 04 | Bryan |
| 4,708,122 | | 1987 Nov. 04 | Rock |
| 6,050,256 | A | 2000 Apr. 18 | French |
| 6,557,547 | B1 | 2003 May 06 | Macintosh |

For many outdoor enthusiasts, whether they be fishing, hunting, snowmobiling, travelling on all-terrain-vehicles, or exploring, fires are often made as a means of staying warm or preparing food. If this is during a cold winter, the fire is often started on the snow or ice. The heat from the fire then melts the snow or ice into water, thereby extinguishing the fire. If the fire is made during a warm season, the problem becomes preventing the fire from spreading to the surrounding environment. To avoid these problems, a fire box is required. But such boxes are cumbersome to carry along since travel space is limited for outdoor enthusiasts.

Although the stove in U.S. Pat. No. 4,708,122 to Rock, 1987 Nov. 4, can be towed by a person, the described tow ropes make it very impractical to be towed by a moving vehicle such as a snowmobile or an all-terrain-vehicle. Furthermore, due to skis being rigidly fixed to a firebox and with little ground clearance provided, the device would have much difficulty negotiating uneven terrain. The device also makes food preparation difficult since there is no place to rest items that are not to be heated. The fact that heat is distributed from one open side of the device also limits the number of people that can benefit from the heat produced. There is also very little storage room for fuel or other gear.

A stove is shown in U.S. Pat. No. 2,677,363 to Bryan, 1984 May 4, for outdoor enthusiasts. Ice-fishing enthusiasts typically bore a hole through the ice on a frozen waterway to be able to present their lure to the fish under the surface of the ice. These holes have a tendency of freezing. French's device is meant to prevent ice-fishing holes from freezing. It provides no means to cook food or produce heat for the user.

A portable cooking apparatus is shown in U.S. Pat. No. 6,557,547 to Macintoch, 2003 May 6, destined for use by caterers. Its large size and plurality of cooking compartments makes this apparatus unsuitable to the outdoor enthusiast.

The movable campfire box in U.S. Pat. No. 6,050,256 to French, 2000 Apr. 18, is equipped with wheels, but this device remains impractical for the outdoor enthusiast wishing to bring along a heat source. French's device is not suitable for snowy or off-road terrains and provides no means for towing.

All the outdoor stoves of which I am presently aware suffer from a number of disadvantages:
a) They are not suited to be towed over rough, multi-season terrain (mud, snow, ice, etc).
b) If they provide grills for food preparation, they are a fixed distance from the heat source and cannot be easily adjusted so as to change the temperature to which the food is subjected.
c) They do not provide means to rest food preparation items outside of the cooking area. For example, cutlery, condiments, or drinks are often required as part of the food preparation process and these items would have to be rested on the ground or on a separate table if these devices are used. Their construction does not provide means to store fuel and other items while in transport.

### SUMMARY

In accordance with one embodiment a portable outdoor stove comprises a fire compartment supported by a frame, a hitch for connecting to a towing vehicle, and skis or wheels attached to the frame.

### Advantages

Accordingly, several advantages of one or more aspects are as follows: an improved stove is provided for outdoor enthusiasts that can be pulled by a towing vehicle over a variety of terrains. The stove can be used to prepare food and to provide means of transporting fuel or gear. Other advantages of one or more aspects will be apparent from a consideration of the drawings and ensuing description.

### DRAWINGS—FIGURES

FIGS. 1A and 1B show various aspects of a stove supplied with a fire compartment, frame, and skis in accordance with one embodiment.

FIGS. 2A to 2G show a stove with an adjustable-height support foot, a removable cover, a grill, and wheels attached to a frame in accordance with another embodiment.

FIGS. 3A to 3E show a stove with a spinnable cover, a storage compartment, and a height-adjustable grill in accordance with another embodiment.

FIGS. 4A and 4B show a stove with skis and wheels that can be interchanged, and a manifold, hose, valve, and reservoir for burning liquid fuel in accordance with another embodiment.

FIGS. 5A and 5B show a stove with a grill that can be rotated, a cover that can be removed from the fire compartment and an adjustable foot that pivots about a point on a hitch in accordance with another embodiment.

FIGS. 6A and 6B show a stove with slots for adjusting the height of a grill in accordance with another embodiment.

FIG. 7 shows a stove with a cylindrical grill post in accordance with another embodiment.

### DRAWINGS—REFERENCE NUMERALS

20 fire compartment
21 frame
22 tow bar
24 hitch
26 ski
27 ski U-bracket
28 support leg
30 fire compartment base
32 crossbar
34 bolt
36 fire compartment handles
38 cover
42 spring
44 eyelet
44a cover eyelet
46 wheel
48 grill storage bracket
50 grill
52 grill post
54 grill pin
56 support foot
58 support foot storage sleeve
60 support foot slider sleeve
62 tang
64 support foot pivot bushing
65 tang pin
66 tightening knob
68 grill support sleeve
70 pin
72 retainer pin
74 trough
80 storage compartment
82 mounting brackets+
83 hitch pin
86 mounting retainer pin
84 mounting pins
90 spinnable cover
92 pin
94 cover support post
96 support leg
97 holes
98 support leg pull pin
100 manifold
102 hose
104 valve
106 fuel reservoir
110 tow bar pull pin
112 support leg pull pin
114 wheel post
120 upper grill post
122 lower grill post
124 detachable cover
126 mounting boss
128 support member
130 pivot bolt
132 locking plate
133 hole
134 locking pin
136 adjustable foot
138 adjustable foot holes
140 adjustable foot pull pin
144 slotted grill post
146 slots
148 tiltable cover
150 hinge
152 cylindrical grill post
154 cylindrical grill post holes
156 grill height adjust pin
158 cylindrical grill sleeve
160 grill

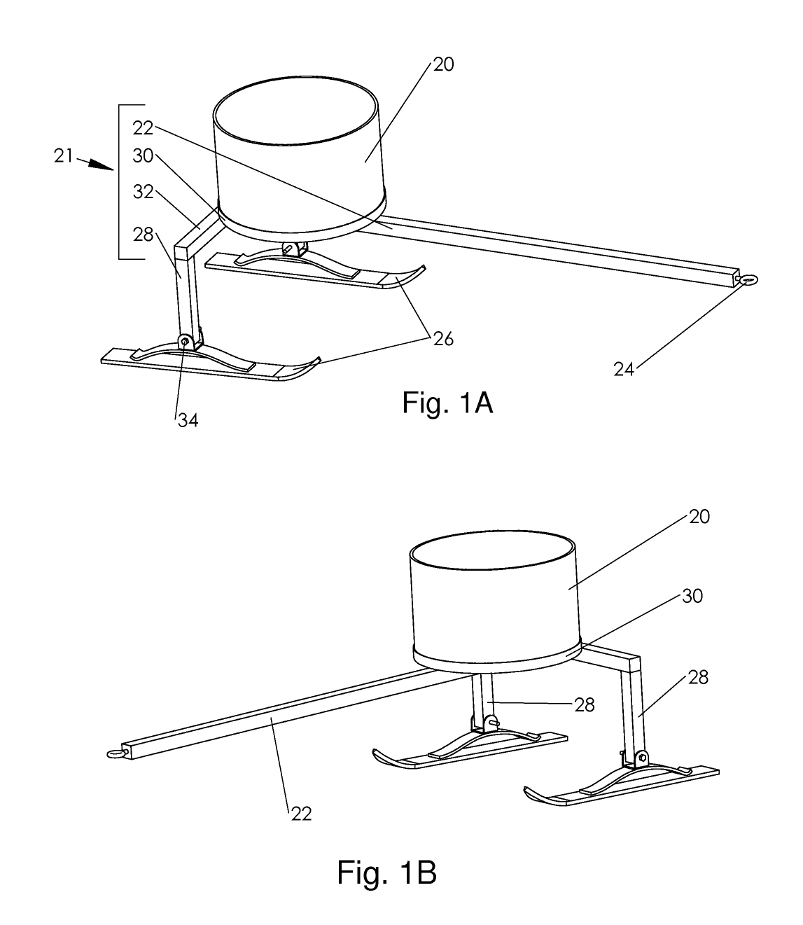

### DETAILED DESCRIPTION—FIGS. 1A, 1B—FIRST EMBODIMENT

One embodiment of my stove is illustrated in FIGS. 1A and 1B. The stove has a tub-shaped fire compartment 20 that is connected to a frame 21. The fire compartment is preferably welded to the frame, but another method of connection can be used: bolting, screwing, clamping, etc. Frame 21 comprises a fire compartment base 30, a tow bar 22, a crossbar 32, and two support legs 28. Crossbar 32 and tow bar 22 are perpendicular to one another. The crossbar is held up by support legs 28. Tow bar 22, crossbar 32, and support legs 28 are all made of square tubing, but may be of other cross-sectional shapes, such as angle, round-tubing, U-shaped tubing, or other profiles. Base 30 has the shape of an ‘L’ that has been swept around the circumference of the fire compartment, but may have other shapes, such as a closed tubing shape. The frame components are welded but may be bolted or pin-jointed for easy disassembly. A hitch 24 is connected to the front of tow bar 22 for connection to a towing vehicle (not shown).

Each support leg is pivotally attached to a ski 26 by a bolt 34. Wheels (not shown in FIG. 1A nor 1B) may also be used as a ground-engagement alternative to skis. Various other means for mounting the ground-engaging means to the support legs are possible including pins, clamps, or other standard fasteners. The frame components are made of a strong structural material such as steel, stainless steal, cast iron, or heat-resistant plastic. If frame 21 is made of a metal that is susceptible to corrosion, such as steel, it is preferably coated or treated to prevent rust formation.

Fire compartment 20 is preferably made of stainless steel, but can be made of other heat-resistant materials, such as carbon steel, tin, copper, or aluminum. If the fire compartment is made of a material that is subject to corrosion, it is preferable to coat its exterior with heat paint. Fire compartment 20 may be fixed to base 30 by welding, bolting, or pinning.

Although shown as having a cylindrical tub-type shape, fire compartment 20 may have any other shape that allows it to hold burning fuel, such as square, rectangular, oval etc. The fire compartment is roughly 500 mm in diameter and 300 mm in height. The frame components support it such that the top of the fire compartment is one meter from the ground. The length of tow bar 22 is roughly 1.5 m.

Hitch 24 is shown as being annular in shape, but may be of any other shape to mate properly with the hitch of the towing vehicle (not shown).

### Operation—FIGS. 1A, 1B

The stove is first connected to a towing vehicle by engaging hitch 24 onto the hitch of the towing vehicle. The towing vehicle may be an all-terrain-vehicle, snowmobile, automobile, or other motorized vehicle. The stove is towed behind the vehicle to a desired location. The user then fills fire compartment 20 with wood, charcoal, or other combustible fuel and ignites it. The heat released from the stove is enough to keep several people comfortably warm. The user may leave the stove hitched onto the towing vehicle or remove it and support the tow bar with an object that will hold the stove in a generally upright position, such as a stump, box, another available object, or a fold-down lever that is hingedly attached to the tow bar. Once the user is ready to leave, the fire is extinguished, the stove is reconnected to the vehicle if it was removed, and the user departs.

### Alternative Embodiments

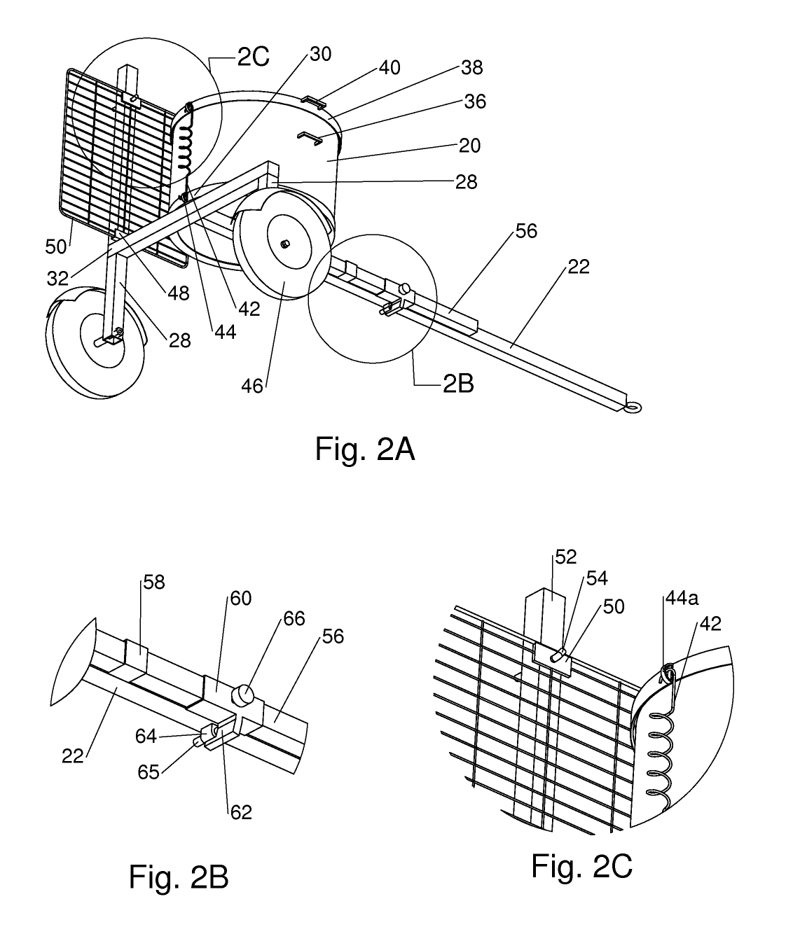

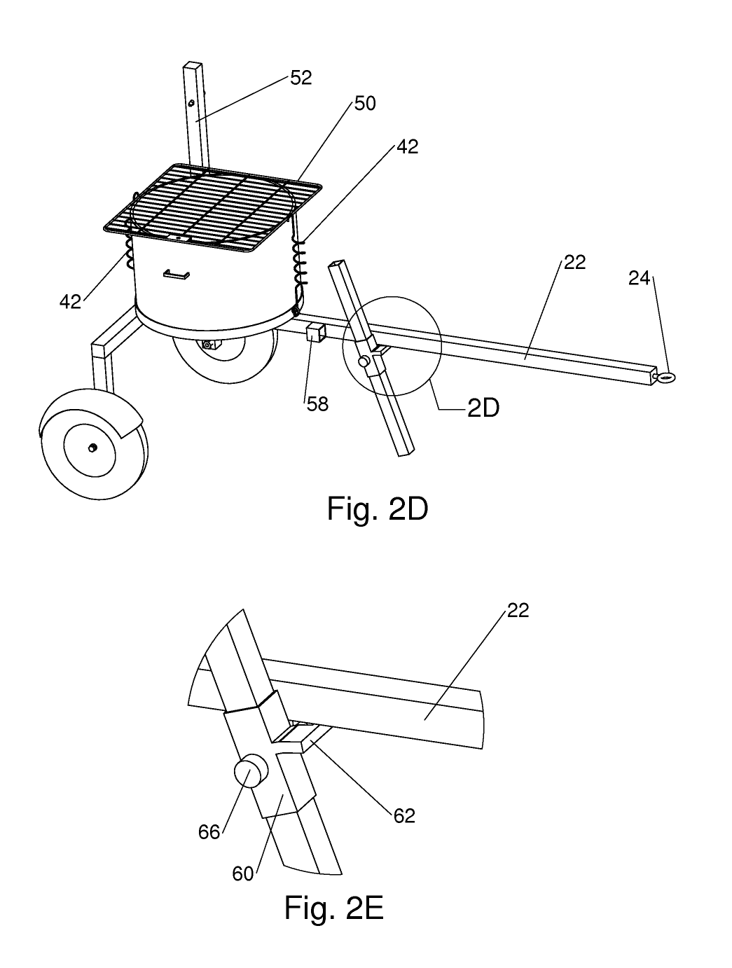

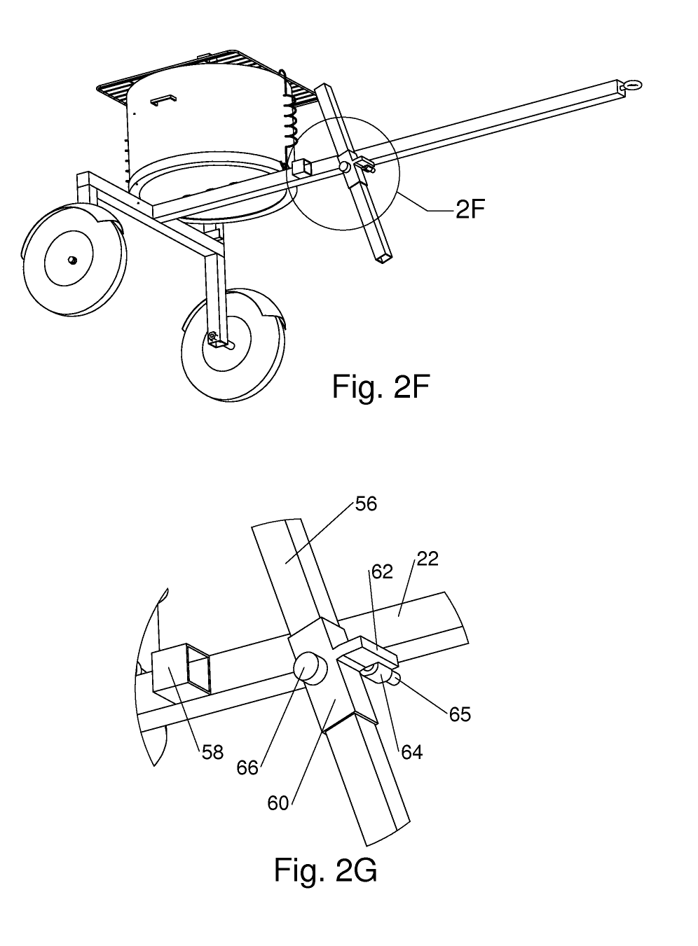

FIGS. 2A to 7 show some alternative embodiments of my stove.

### Alternative Embodiment—FIGS. 2A to 2G

FIG. 2A shows an alternative embodiment in a travel position, ready to be towed. A cover 38 is shaped to sit over fire compartment 20. Spring 42 holds the cover down during transport by engaging an eyelet 44 on base 30 and a cover eyelet 44a on cover 38, as seen in FIG. 2C. Two springs 42 hold the cover down, one at the front of the fire compartment, and one at the back. Two fire compartment handles 36 are attached to the side of the fire compartment. Fire compartment 20, instead of being rigidly connected to the base 30, is simply held in place under the force that springs 42 exert on cover 38. This allows the fire compartment to be easily removed from the frame for emptying.

As seen in FIG. 2B, a support foot 56 can slide within a support foot storage sleeve 58 and a support foot slider sleeve 60. Foot 56 is shown as square tubing but may have another shape such as a rod, an extrusion, a pipe etc. Foot 56 is preferably made out of carbon steel but may be made out of aluminum, stainless, plastic or another strong material. A tightening knob 66 is threaded into sleeve 60 so that by tightening it, foot 56 is fixed in place. Sleeve 58 is rigidly attached to tow bar 22. Slider sleeve 60 has a tang 62 that protrudes roughly perpendicularly from one of its surfaces. A tang pin 65 protrudes from the tang and engages a support foot pivot bushing 64. Pivot bushing 64 is attached to tow bar 22. Sleeve 60, tang 62, and tang pin 65 form one solid piece that is allowed to rotate within pivot bushing 64.

FIGS. 2A and 2C show a grill post 52 rigidly connected to crossbar 32. A grill 50 is fixed in a storage position by being held at its base between a grill storage bracket 48 and grill post 52, and at its top by a grill pin 54 that holds it against grill post 52. Instead of skis, wheels 46 can be connected to support legs 28; this allows the stove to be towed over ground. Wheels 46 are preferably rubber tires but may be of another material suitable for wheel construction, such as soft plastic.

### Operation—FIGS. 2A to 2G

Referring to FIGS. 2B and 2G, one tows the stove to the desired location, sets support foot 56 in place, and disengages the hitch from the towing vehicle. The support foot is set in place by first loosening knob 66 so that foot 56 may slide within the sleeves 58 and 60 so as to be disengaged from sleeve 58. Foot 56 and sleeve 60 can then be rotated together in a counter-clockwise direction about pivot bushing 64. This rotation will be stopped when tang 62 butts against the underside of tow bar 22, as best shown in FIG. 2G. Tang 62 is shaped so that when it butts against the tow bar, foot 56 is leaning back slightly; this allows the weight of the stove to keep tang 62 forced against the bottom of tow bar 22. Foot 56 is then slid to an appropriate height so as to maintain the stove in a generally level position, and knob 66 is tightened.

As shown in FIGS. 2A, 2C, and 2D, springs 42 are then removed from the eyelets 44a so that cover 38 is free to be removed and set aside. The top of the springs are then hooked onto the fire compartment to hold it down. Any gear or fuel that was being transported inside the fire compartment is removed. Grill pin 54 is disengaged from grill post 52 so that grill 50 is free to be removed from its storage position. Once fuel is burning inside the fire compartment, the grill can be placed on the fire compartment, as shown in FIG. 2D.

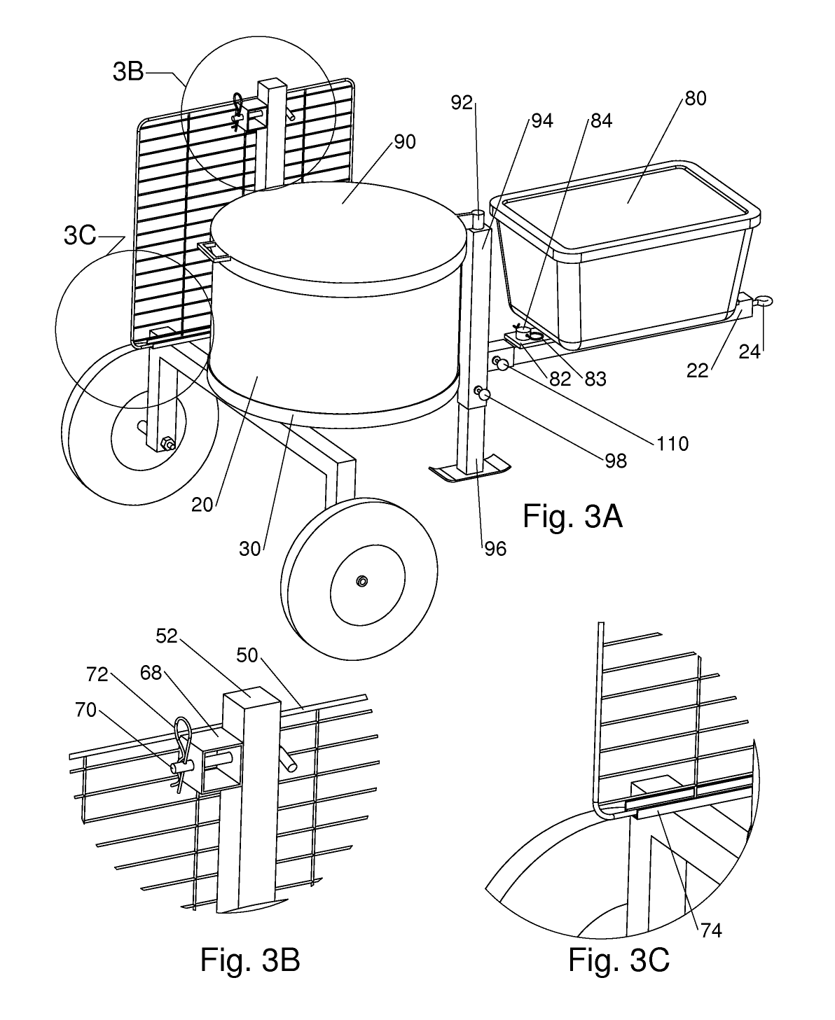

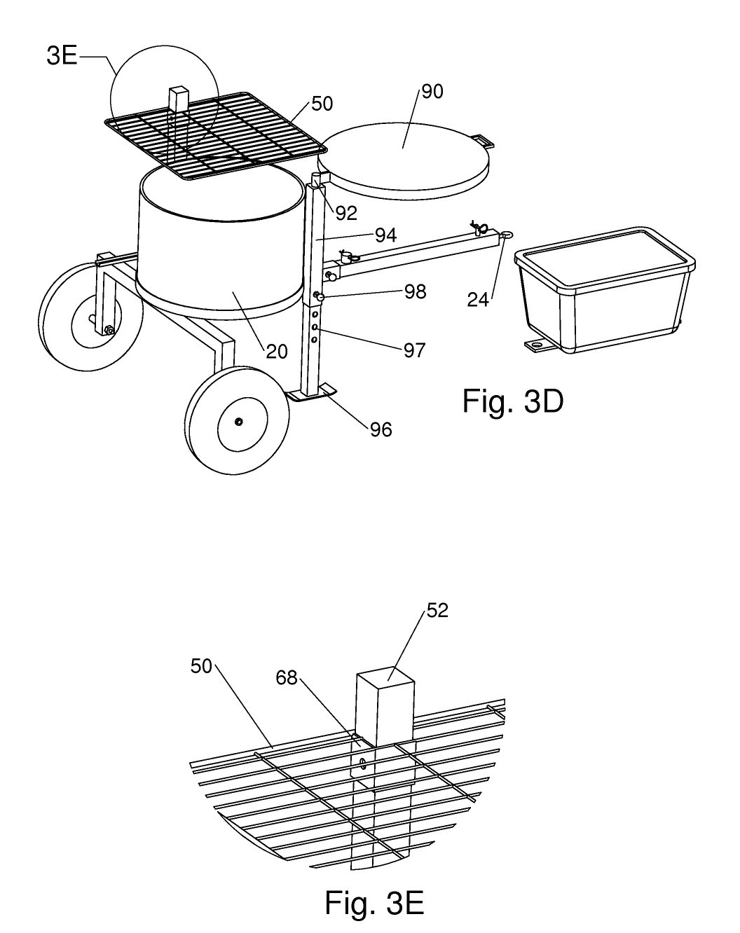

### Alternative Embodiment—FIGS. 3A to 3E

As shown in FIG. 3A, a storage compartment 80 is provided to allow for extra storage space. Storage compartment 80 is generally rectangular in shape but may have another shape such as cylindrical or oval. The storage compartment has mounting brackets 82 connected to it that engage mounting pins 84. The mounting pins are connected to tow bar 22. A hitch pin 83 can be pulled out of mounting pin 84 to allow the removal of the storage compartment from the tow bar. The storage compartment can also be rigidly fixed to the frame by welding, bolting, screwing, etc. Tow bar 22 can be removably fixed to the rest of the frame by means of a tow bar pull pin 110; this allows the tow bar to be removed if the stove is installed in a certain location in a semi-permanent manner.

A spinnable cover 90 fits over the fire compartment and has a pin 92 that can slide longitudinally within a vertical bore in a cover support post 94. This allows the cover to be moved upward, allowing it to clear the fire compartment and then spin about post 94; this allows the cover to remain near the cooking area while its surface can be used as a table to hold cooking items.

As shown in FIGS. 3A, 3B, and 3C, a grill support sleeve 68 is rigidly attached to grill 50. Sleeve 68 is dimensioned so as to closely fit over grill post 52. Grill 50 is stored on the stove by sitting in a trough 74 and having a pin 70 engage grill post 52 and sleeve 68. A retainer pin 72 perpendicularly engages pin 70 to hold it in place. Many other types of standard fastener configurations may be used instead of pin 70.

FIG. 3D shows a support leg 96 that fits within post 94 and can be pinned at different heights by a support leg pull pin 98 that engages one of a plurality of holes 97 in leg 96. Support leg 96 can also slide within its own dedicated sleeve—it need not slide within the same post that is used to support cover 90.

### Operation—FIGS. 3A to 3E

Referring to FIG. 3D, once towed to the desired location, one disengages the hitch from the towing vehicle and adjusts support leg 96 to a suitable height to maintain the stove in a level position. The height of leg 96 is adjusted by pulling pull pin 98, sliding leg 96 within post 94 to a suitable height, then reengaging pin 98 to hold leg 96 at that height.

Cover 90 is lifted so as to clear the upper edge of fire compartment 20; this is allowed by cover pin 92 that slides longitudinally within post 94. Pin 92 also allows the grill to be spun out of the way of the fire compartment. One can then use the cover to as a table surface, to hold cooking items or other objects. As seen in FIG. 3B, to remove the grill, the retainer pin 72 is removed which allows the removal of pin 70, which in turn frees grill 50.

As shown in FIG. 3E, the grill can then be slid over post 52. The cantilevered weight of the grill creates a binding action between grill post 52 and grill sleeve 68. To change the height of the grill, one can lift slightly on the grill, which will release the binding action between the grill sleeve and the grill post. One then moves the grill to an appropriate height by moving the sleeve side of the grill at the same time as the opposite side in order to avoid the binding action. Once the desired height is reached, the grill is released, he binding action resumes and the grill stays in place.

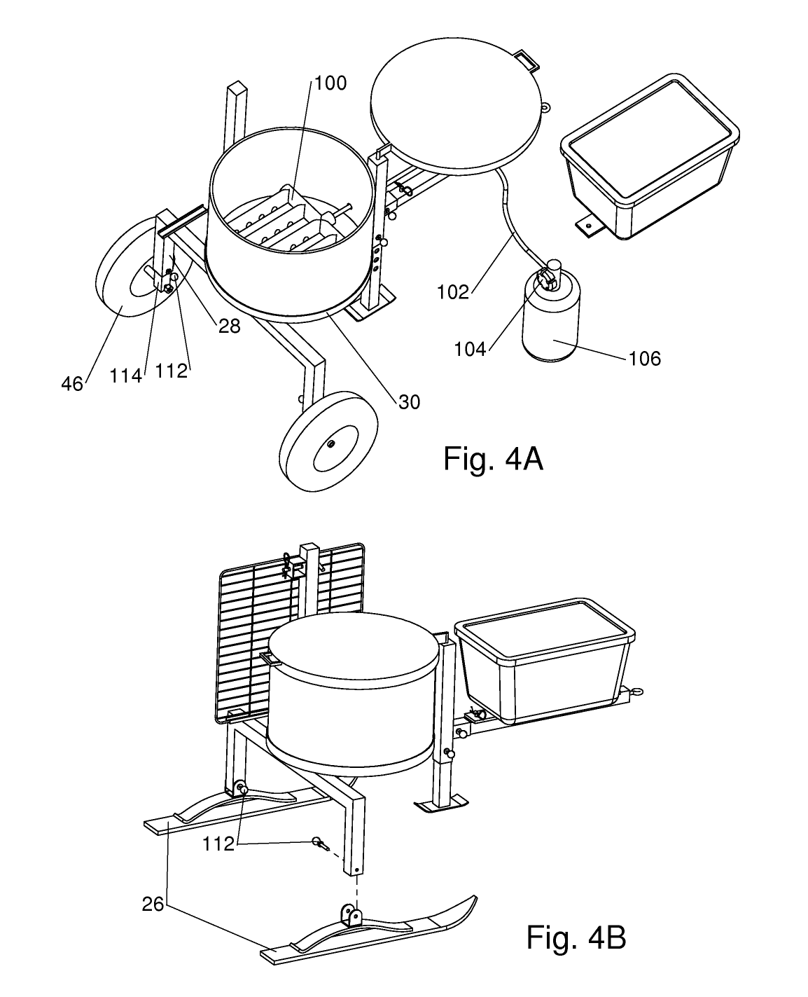

### Alternative Embodiment—FIGS. 4A and 4B

A manifold 100 is attached to the bottom of fire compartment 20. The manifold is connected to a fuel reservoir 106 by a hose 102. Fuel reservoir 106 has a valve 104 that regulates the flow rate of fuel leaving the reservoir.

Wheel 46 is bolted to a wheel post 114 which fits inside support leg 28. Post 114 is secured within support leg 28 by a support leg pull pin 112. This allows wheels 46 to be exchanged for skis 26. The stove can thereby easily be converted from a summer to winter use, and vice versa.

### Operation—FIGS. 4A and 4B

Before leaving with the stove, the user can choose which ground engagement would be most appropriate: wheels or skis. In either case, pull pin 112 is removed and the appropriate ground engagement is chosen; if wheels are desired, wheel posts 114 are slid up into support legs 28 and the pull pins are reengaged; if skis are desired, the U-brackets are slid over support legs 28 and the pull pins are reengaged to pivotally join the skis to the support legs.

Once the user arrives at the desired location, they can remove the stove from the towing vehicle (not shown), set it in place, and level it. The cover is removed or swung aside as described in previous embodiments. The storage compartment is removed and reservoir 106 is connected to manifold 100 via hose 102. Valve 104 is opened to let fuel flow from reservoir 106 to manifold 100. Fuel flowing out of manifold 100 is ignited and the grill is set in place to start food preparation.

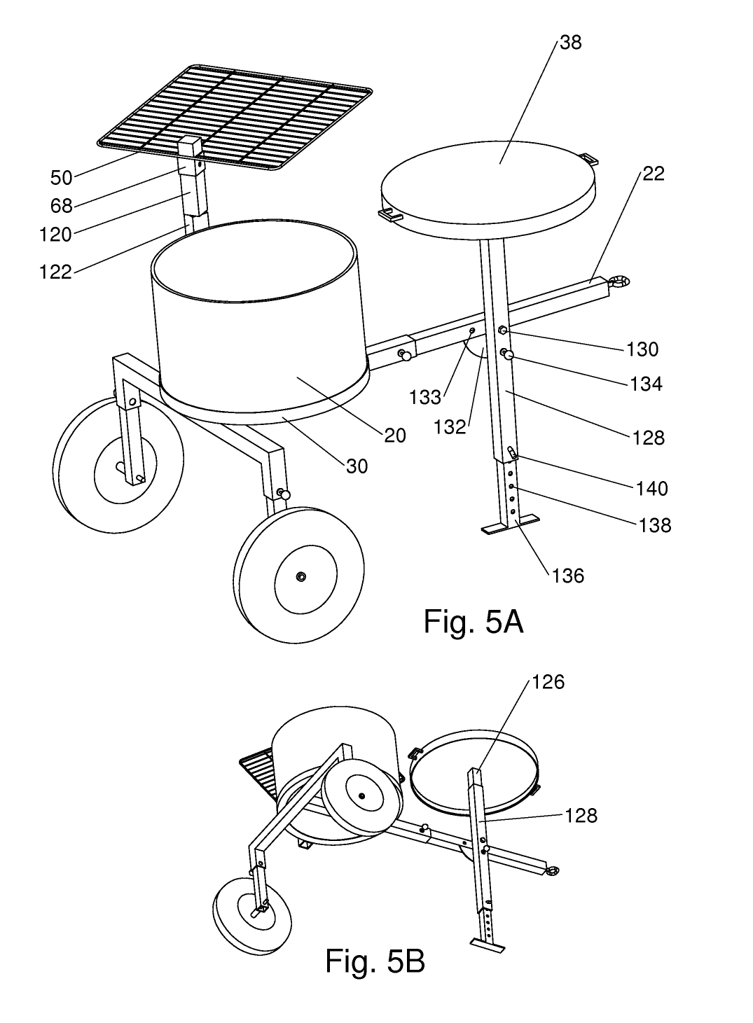

### Alternative Embodiment—FIGS. 5A, 5B

A support member 128 is connected to tow bar 22 by a pivot bolt 130. A locking plate 132 is mounted flush with a vertical side of the tow bar. A locking pin 134 pins member 128 so that the latter is either perpendicular or parallel to tow bar 22. When member 128 is perpendicular, pin 134 engages a hole in locking plate 132 (not shown). When member 128 is parallel to tow bar 22, pin 134 engages a hole 133 in tow bar 22. An adjustable foot 136 slides within member 128 and is fixed in place by adjustable foot pull pin 140 that engages member 128 and one of a plurality of holes 138 in foot 136. Cover 38 has a mounting boss 126 on its underside that is dimensioned to slide into support member 128.

A lower grill post 122 is rigidly fixed to base 30. An upper grill post 120 is pivotally joined to lower grill post 122 so that the upper grill post may rotate relative to the lower grill post about a longitudinal axis. Grill 50 has a grill sleeve 68 and engages post 120 in a way similar to previous embodiments.

This embodiment shows support member 128 serving a double function: supporting the cover and acting as a support foot. These two functions however can be fulfilled by two separate members; the support member 128 may be rigidly fixed to the frame and another, separate pivoting member can exist for the function of supporting the tow bar.

### Operation—FIGS. 5A, 5B

The stove is towed with member 128 in a horizontal position. Once at the desired location, one disengages pin 134 and rotates member 128 to a vertical position. Pin 134 is then engaged in a hole in locking plate 132 (not shown) to maintain member 128 vertical. Foot 136 is adjusted to a proper height by disengaging pin 140 and reengaging it in an appropriate hole 138 so that the stove is level.

Cover 38 is removed from fire compartment 20 and placed on member 128 so that it may serve as a table. Any gear or fuel that was transported in fire compartment 20 is removed. Grill 50 is slid over upper grill post 120 and can be adjusted in height in the same way as described in previous embodiments. Upper grill post 120 can rotate about lower grill post 122 so that grill 50 can be spun away from the fire compartment. The ability of grill 50 to rotate allows to control the amount heat exposed to the food or to clear the way to tend to the fire.

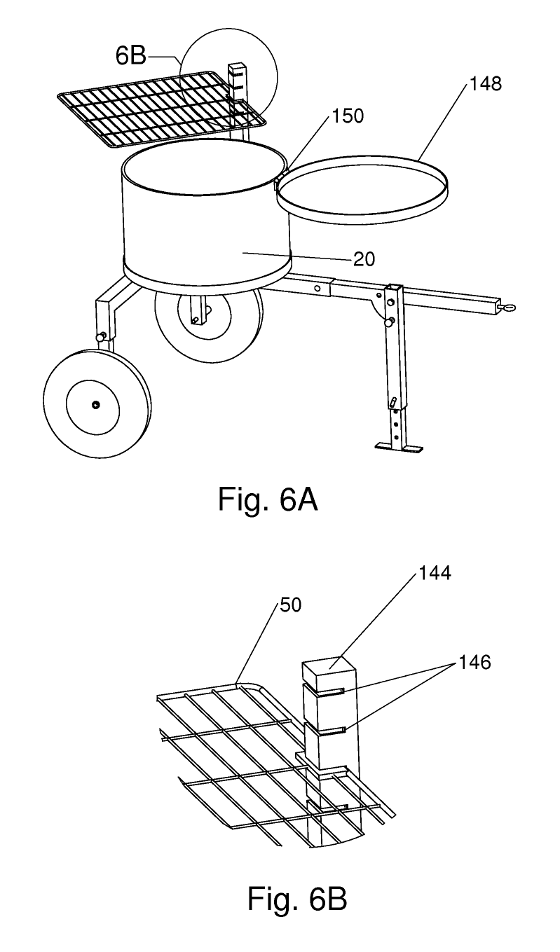

### Alternative Embodiment—FIGS. 6A and 6B

A tiltable cover 148 is attached to fire compartment 20 via a hinge 150. A slotted grill post 144 has a plurality of slots 146 that can receive grill 50. In operation, cover 148 can rotate about hinge 150 between two positions: closed, when it is covering fire compartment 20; and open as shown in FIG. 6A. In the open position, cover 148 acts as a table. One can adjust the height of grill 50 by inserting it into different slots 146.

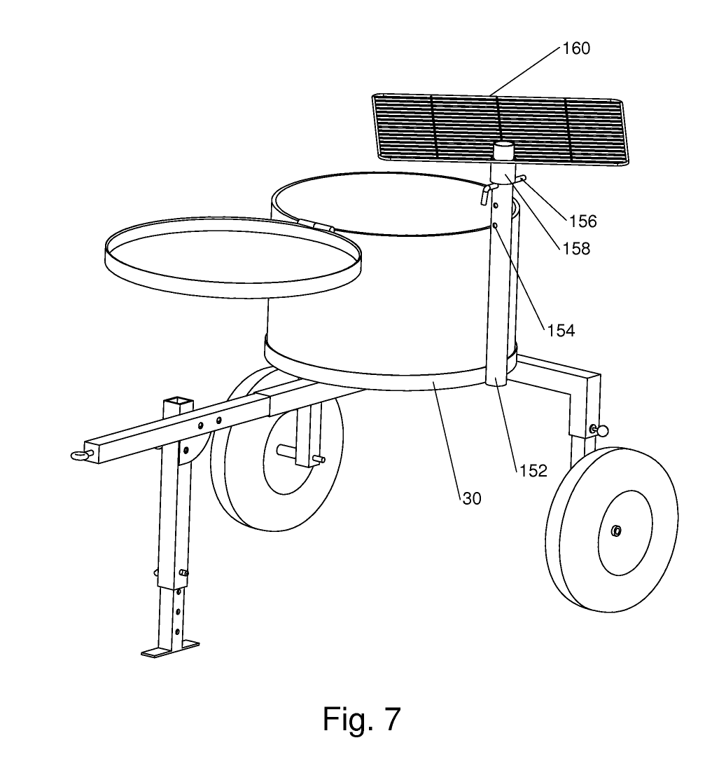

### Alternative Embodiment—FIG. 7

As shown in FIG. 7, a cylindrical grill post 152 is rigidly fixed in a vertical position to base 30. A plurality of holes 154 are provided in the top part of post 152. A grill 160 has a cylindrical grill sleeve 158 that is sized to slide freely over post 152. A grill height adjust pin 156 is provided to support cylindrical grill sleeve 158.

In operation, one slides grill 160 over post 152 and sets pin 156 to support the grill at an appropriate height. The plurality of holes 154 allows the grill to be set at various heights. One can rotate the grill away from the fire compartment to reduce the cooking heat or to have clear access to the fire compartment.

### Advantages

From the description above, a number of advantages of some embodiments of my portable outdoor stove become evident:

(a) Outdoor enthusiasts are able to easily bring with them behind their all-terrain-vehicle or snowmobile a portable heat source to stay warm and prepare food.

(b) The stove doubles as a trailer, allowing the user to carry extra gear.

(c) The stove may be used in winter or summer, in temperate or Nordic climates, since either wheels or skis may be attached to it.

(d) The adjustable-height grill allows the cooking temperature to be controlled.

(e) The grill can easily be spun out of the way, which gives clear access to the fire compartment to add fuel or tend to the fire.

(f) The cover doubles as a table that can hold various items that are useful for cooking, such as utensils, condiments, oven mitts, etc.

(g) The stove need not be permanently associated with a towing vehicle: it can easily be permanently set-up in a fixed location.

(h) The stove can be used with gaseous fuel such as propane, or solid fuel, such as wood or charcoal.

(i) Although primarily moved by a towing vehicle such as a snowmobile or all-terrain-vehicle, the stove is light enough to be moved by a single person.

Conclusions, Ramifications, and Scope

Accordingly, the reader will see that the portable outdoor stove of the various embodiments can be conveniently towed behind a snowmobile or all-terrain-vehicle over a variety of terrains, can store fuel and gear, can be used to warm persons and cook food. In addition, the cooking temperature can be conveniently varied by changing the height of the grill, and the cover acts as a convenient table to hold items during cooking. Also, the stove can be permanently installed outside on its own without being connected to a snowmobile or all-terrain-vehicle. It is light enough to be moved by a person. Furthermore, the stove has the additional advantages in that:
it allows solid or gaseous fuels to be burned
it permits the easy exchange of wheels and skis, to accommodate travel over ground or snow and ice.
the fire compartment is easily removable, allowing leftover ash to be easily disposed of.
pin-jointed connections allow easy dismantlement for storage and transportation
an extra storage compartment provides plenty storage for gear and fuel
the adjustable foot support allows the stove to be maintained in a horizontal position, even on rugged terrain.

Although the description above contains many specificities, these should not be construed as limiting the scope of the embodiments but as merely providing illustrations of some of several embodiments. For example, the fire compartment can have other shapes, such as oval, rectangular, square, etc.; the grill post can be mounted near the front or near rear of the fire compartment instead of on the side; the structural members can have rectangular, circular or other cross-sectional shapes; various types of standard trailer jacks can be used instead of the adjustable foot; various types of pull-pins may be used including detent pins, spring-loaded pins, cotter pins, trailer hitch pins, etc. Several different combinations of features from the various embodiments can be selectively used or discarded; for example, the grill post that allows the height adjustment of the grill in some embodiments can be rigidly connected to the frame without pivoting about the lower grill post; such a combination allows for the varying of the grill height without allowing grill rotation. Many other combinations of features are possible.

Thus the scope of the embodiments should be determined by the appended claims and their legal equivalents, rather than by the examples given.

I claim:

1. A portable stove, comprising:
(a) a frame including a hitch and at least two support legs;
(b) a fire compartment and means for mounting said fire compartment on said frame;
(c) ground-engaging means for supporting said frame on the ground and means for mounting said ground-engaging means to said support legs;
whereby a person may tow said portable stove behind a towing vehicle and use it to cook meals and stay warm out of doors.

2. The portable stove of claim 1 wherein said ground-engaging means is a pair of skis.

3. The portable stove of claim 1 wherein said ground-engaging means are a plurality of wheels.

4. The portable stove of claim 1 wherein said means for mounting said ground-engaging means to said support legs is a demountable connection, thereby allowing different ground-engaging means to be interchanged, said different ground-engaging means being selected from the group consisting of skis and wheels.

5. The portable stove of claim 1, further including a support foot connected to said frame, thereby allowing said stove to be maintained in a generally horizontal position.

6. The portable stove of claim 1, further including a cover, said cover dimensioned such that it fits over said fire compartment.

7. The portable stove of claim 6, further including a cover support post having a vertical bore, a pin being able to rotate and slide longitudinally within said bore, said cover being rigidly fixed to said pin, thereby allowing said cover to be disengaged from said fire compartment and rotated away from said fire compartment such that said cover can be used as a table and said fire compartment is unobstructed by said cover.

8. The portable stove of claim 6, further including a hinge, said hinge joining said cover to said fire compartment, thereby allowing said cover to be tilted to an inverted position for use as a table

9. The portable stove of claim 6, further including a mounting boss fixed to the underside of said cover, a support member attached to said frame, said support member shaped to mate with said mounting boss, thereby allowing said cover to be removed from said fire compartment and mated with said support member so as to maintain said cover in a generally horizontal position while leaving fire compartment unobstructed.

10. The portable stove of claim 1, further comprising a storage compartment demountably fixed to said frame.

11. The portable stove of claim 1 wherein said means for mounting said fire compartment allows said fire compartment to be removed from said frame, thereby allowing easy emptying of said fire compartment.

12. The portable stove of claim 1 wherein said means for mounting said fire compartment to said frame comprises a plurality of springs, each of said springs connected on one end to said frame, and opposite end of each said spring hooked onto said fire compartment.

13. The portable stove of claim 1, further including a grill and means for positioning said grill above said fire compartment.

14. The portable stove of claim 13 wherein said means for positioning said grill comprises: a grill support sleeve rigidly connected to said grill, said support sleeve fitting over an upper grill post, the cantilevered weight of said grill causing a binding action between said support sleeve and said upper grill post, the location of said binding action being able to be moved by lifting on said grill and sliding said grill to a desired height before releasing said grill, said upper grill post pivotally connected to a lower grill post for allowing rotation of said upper grill post about its longitudinal axis, said lower grill post rigidly connected to said frame near said fire compartment, said grill thus being able to rotate about said lower grill post in order to clear access to said fire compartment.

15. The portable stove of claim 13 wherein said means for positioning said grill comprises: a grill post having a plurality of slots capable of accepting said grill such that said grill may assume various heights above said fire compartment.

16. The portable stove of claim 1 further including a manifold, said fuel manifold fixed at the bottom of said fire compartment, a fuel reservoir, a valve connected to said fuel reservoir, and a hose for connecting said valve to said fuel manifold, thereby allowing fuel from said reservoir to be burned in said fire compartment.

17. A portable stove, comprising:
(a) a frame including a hitch and at least two support legs;
(b) a fire compartment;
(c) skis pivotally connected to said support legs;
(d) a removable cover shaped to enclose the top of said fire compartment;
(e) a grill;
(f) a grill support post that can hold said grill at varying heights above said fire compartment;
whereby a person may tow the portable stove behind a towing vehicle and use it to cook meals and stay warm out of doors.

18. A method of cooking food, comprising:
(a) providing a stove comprising a fire compartment, a frame supporting said fire compartment including a hitch and two support legs, ground-engaging means connected to said support legs for supporting said support legs on the ground, a support foot that is adjustable in height and is attached to said frame, a grill post connected to said frame, and a grill that is demountably fixed to said grill post and can be positioned thereon to vary its height above said fire compartment,
(b) towing said stove to desired location by use of a towing vehicle connected to said frame,
(c) removing said stove from said towing vehicle,
(d) setting in place said support foot as to maintain said stove in an upright position,
(e) providing a combustible fuel and inserting said combustible fuel into said fire compartment,
(f) igniting said fuel, and
(g) placing foodstuff on grill above fire for it to be heated,
whereby a person may tow the portable stove behind a towing vehicle and use it to cook meals and stay warm out of doors.

19. The method of claim 18 wherein said ground-engaging means is a pair of skis.

20. The method of claim 18 wherein said ground-engaging means is a plurality of wheels.
